(19) United States
(12) Patent Application Publication
(10) Pub. No.: US 2022/0338444 A1
(43) Pub. Date: Oct. 27, 2022

(54) PET BALL WITH ANCHORED NOISEMAKER

(71) Applicant: John J. Stone, Golden, CO (US)

(72) Inventor: John J. Stone, Golden, CO (US)

(21) Appl. No.: 17/239,648

(22) Filed: Apr. 25, 2021

(51) Int. Cl. A01K 15/02; G10K 15/04; G10K 9/02

(52) U.S. Cl. CPC A01K 15/025; G10K 15/04; G10K 9/02

(57) ABSTRACT

The invention comprises a novel pet ball with an anchored squeaker which will not break or otherwise be inoperable by a firm bite of a pet. A malleable inner and outer shell construction makes the ball simple yet less prone to damage as it allows the squeaker insert to move to a degree in response to pressure of a bite. The squeaker cannot be dislodged from int's insert. The outer shell of a wooly fabric covers the exit portion of the squeaker yet allows sound and air to travel though the ball.

### FIELD

The invention relates to a novel pet ball with a noisemaking device anchored securely within the ball, and which is moveable in response to pressure so as not to pose the risk of breaking parts and thus a choking hazard to a pet, as well as extended life of the ball since the squeaker is securely anchored with in the ball.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel pet ball with a squeaker which is anchored within the ball in such a way as to avoid it coming out of the ball, and also extended the life of the toy as a result of the anchoring design.

Most pet toys with squeakers or noisemakers inside of a ball or other malleable shape simply insert the squeaker port inside of the toy and cap it off with a fabric covering, or some leave the end of the squeaker port flush with an edge of a shell yet showing the air intake/exit.

### THE INVENTION

### Summary, Objects and Advantages

The inventive ball has a malleable rubber interior shell with its center hollow except for the squeaker anchor port which is molded into only that interior shell. The insert for the squeaker is malleable so that upon pressure, the squeaker in port will move versus being rigid and potentially causing damages to the squeaker. That first half of the ball contains only the squeaker port. The second half of the ball is hollow with no structure within. The two halves are joined using heat and a fixative. An exterior shell can be created using a fabric such as felt which covers the entire interior shell, including the squeaker port, yet is porous enough so that the noise may be emitted from the squeaker through that material.

The squeaker piece is nested within its molded insert and contains two circumferential ridges or lips which retain the squeaker within its insert wherein the ridges embed into the insert material and will not become dislodged. The squeaker and ridges are a single molded piece. Additionally, the outer shell fabric covers the speaker port adding additional structural integrity.

### BRIEF DESCRIPTION OF THE DRAWINGS

The invention is described in further detail by reference to eight (8) drawings sufficient in detail to describe the invention in which:

FIG. 1 is a cutout perspective of the first half of the ball;

FIG. 2 is a cutout perspective of the second half of the ball;

FIG. 3 is a side perspective of the molded squeaker showing the two circumferential ridges;

FIG. 4 is a side perspective of the ball showing the outer shell;

FIG. 5 is a magnified perspective of the ball indicating wooliness of the fabric;

FIG. 6 is a cutout perspective of the first half of the ball with squeaker inserted;

FIG. 7 is a side perspective of the ball; and

FIG. 8 is a top perspective of the ball.

### DETAILED DESCRIPTION, INCLUDING BEST MODES OF CARRYING OUT THE INVENTION

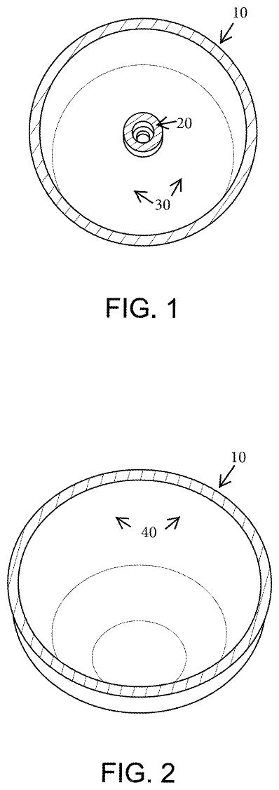

FIG. 1 illustrates a cutout of the first half of the ball showing only the interior shell 10 and the molded squeaker port 20 from a top-down angle. The remainder of the first half of the ball is hollow 30 wherein that hollow space aids in forcing air through the squeaker when compressed by an animal. In contrast to U.S. Pat. No. 10,433,523 Stone et al., there are only two shells to the ball and the 2 ridges around the inventive squeaker maintain its position within the insert and contains no other internal material or structure. As opposed to the prior art, there are no “plurality of tiers and grooves located between tiers” or any layers of the inventive ball's shells. Nor are there “annular protrusions” in any layer of the inventive ball.

FIG. 2 is a cutout of the second half of the ball wherein this half of the ball 40 is void of structure and is hollow. As in FIG. 1, again only the first layer 10 of the interior shell is shown.

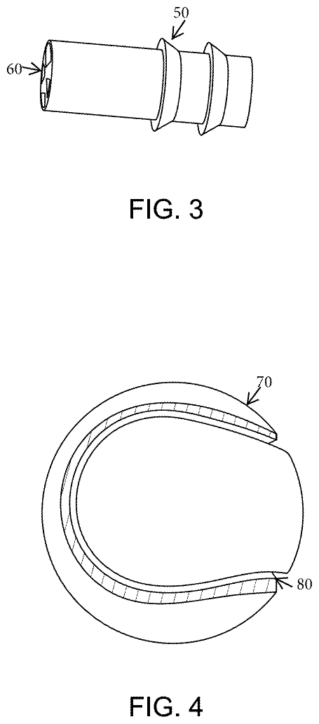

FIG. 3 is an illustration of the squeaker showing the two molded ridges 50 and the exit port 60 wherein airflow causes the squeaker to emit noise.

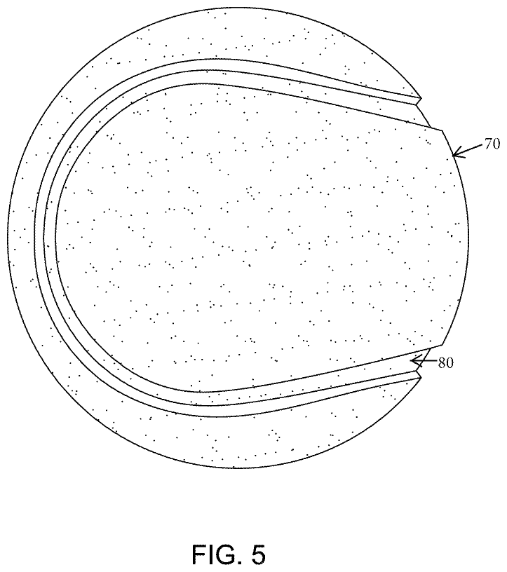

FIG. 4 illustrates the outer shell 70 and channels therethrough 80 to resemble a standard tennis ball. The outer shell is made of a wooly fabric such as felt and covers the exit channel 80 and is porous enough as not to impede the squeaker from creating a sound.

FIG. 5 is a magnified perspective of the wooly outer shell fabric 70, and again illustrates the grooves 80 which make the ball resemble a standard tennis ball.

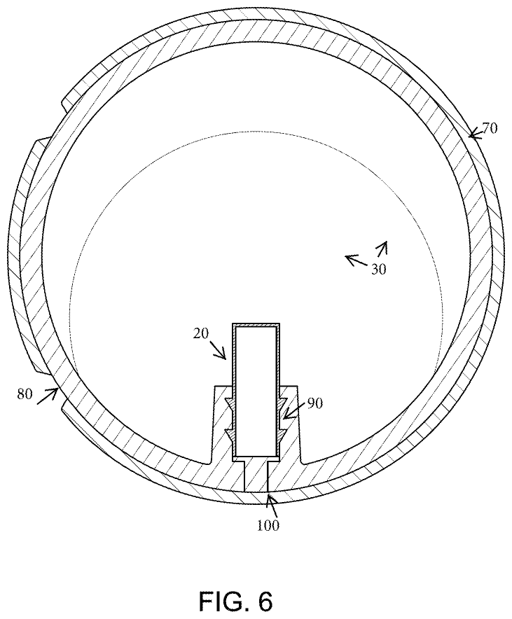

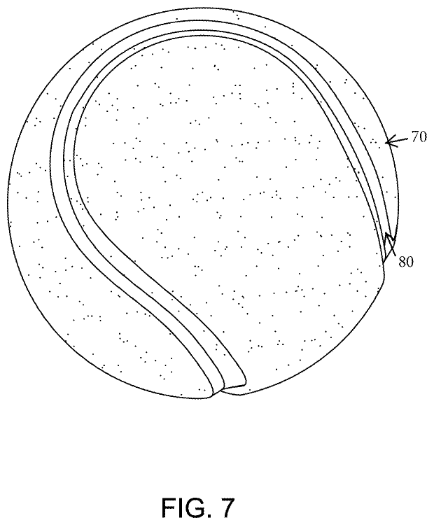

FIG. 6 is key in that it shows the first and second layers of the ball, and the molded squeaker port with ridges retaining the squeaker within its molded insert. The outer shell 70 covers the entirety of the ball including the mouth of the squeaker. The channels 80 are again shown to illustrate the resemblance to a standard tennis ball. The inner portion of the ball is hollow 30 with exception for the squeaker and insert. This void space allows the ball to depress when an animal bites on the ball, and also allows the squeaker to move in its insert so as to be less likely to break and become dislodged. The two circumferential ridges on the squeaker 90 maintains the squeaker's position within the insert and will move in response to pressure from the pet's bite. The external layer covers what would be the exit aperture of the squeaker 100. The porous fabric allows sound to be emitted from the squeaker even though covered. U.S. Pat. Nos. 7,201,117 and 7,343,878 claim the process of making a noisemaking ball, but the steps and layers of the inventive ball do not read on the Claims of said Patents even if the Inventor was claiming a method herein. U.S. Pat. No. 9,814,994 claims only two prongs circumferentially spaced 180 degrees from each other on the side wall” of the squeaker insert which make it less effective than the inventive ball's squeaker insert.

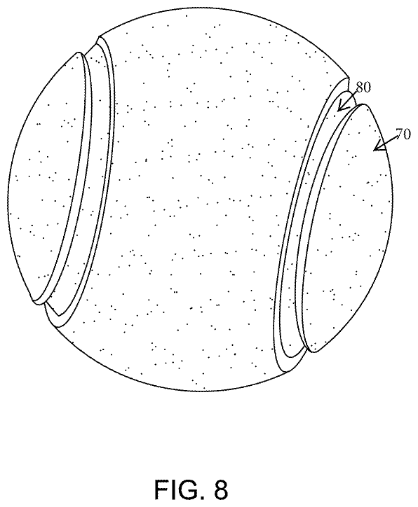

FIG. 7 is a magnified view of the outer shell being a wooly fabric 70 such as felt and the grooves 80 which allow the ball to resemble a standard tennis ball.

FIG. 8 is a top-down view of the ball indicating that the grooves 80 encircle the ball as does the wooly outer layer fabric 70.

1. A sound emitting pet ball comprising;
b) an outer shell constructed of fabric
c) an inner shell which has a molded squeaker insert section
d) a first half with a molded insert for receiving a proprietary squeaker
e) a second half joinable to the first half without structure within the second half
f) a malleable insert wherein a ribbed squeaker resides within the molded insert
d) two circumferential ribs molded to a squeaker which is secured within the insert
e) a covered squeaker exit port

2. A sound emitting pet ball as in claim 1 wherein the outer shell of the ball is constructed of a wooly fabric such as felt, and which outer shell covers the entirety of the ball.

3. A sound emitting pet ball as in claim 1 wherein the inner shell is a malleable material and responds to compression as well as housing the molded squeaker insert, and which insert will move in response to pressure from an animal bite to an extent that the squeaker will not break within the insert and possibly dislodge from the ball.

4. A sound emitting pet ball as in claim 1 wherein the second half of the ball is hollow to allow air flow without obstruction within the ball when the halves are joined together via heat and fixatives.

5. A sound emitting pet ball as in claim 1 wherein the one-piece squeaker housing has two circumferential ribs which keep it within the squeaker insert in response to shifting caused by the pressure of a pet's bite and compression thereof so that the squeaker does not break.

6. A sound emitting pet ball as in claim 1 wherein the exit aperture of the squeaker is flush with the inner shell but is covered by the outer shell so that noise may still be emitted while the squeaker is not contacted directly by aa pet in an effort to provide longevity of the ball and safety for the pet.
